(19) United States
(12) Patent Application Publication
(10) Pub. No.: US 2025/0309397 A1
(43) Pub. Date: Oct. 2, 2025

(54) BATTERY

(71) Applicant: TOYOTA JIDOSHA KABUSHIKI KAISHA, Toyota-shi (JP)

(72) Inventors: Hiromasa TANAKA, Okazaki-shi (JP); Takayuki SUGIYAMA, Toyota-shi (JP); Motokuni MARUHASHI, Toyota-shi (JP); Akio UOTANI, Toyota-shi (JP); Kazuya KUMAZAWA, Nagoya-shi (JP)

(73) Assignee: TOYOTA JIDOSHA KABUSHIKI KAISHA, Toyota-shi (JP)

(21) Appl. No.: 19/077,219

(22) Filed: Mar. 12, 2025

(30) Foreign Application Priority Data
Mar. 27, 2024 (JP) 2024-051508

(51) Int. Cl. H01M 10/653; H01M 10/613; H01M 10/647; H01M 50/209; H01M 50/264; H01M 50/548; H01M 50/588; H01M 50/593

(52) U.S. Cl. CPC H01M 10/653; H01M 10/613; H01M 10/647; H01M 50/209; H01M 50/264; H01M 50/548; H01M 50/588; H01M 50/593

(57) ABSTRACT

A battery includes a cell stack having a rectangular parallelepiped shape in which a plurality of rectangular cells with terminals disposed on both end faces in a longitudinal direction thereof are stacked on one another, and a case configured to house the cell stack therein. The cell stack includes a metal binding member configured to bind each of lower ends in the longitudinal direction of the plurality of rectangular cells, and the binding member is fixed to the case by a thermally conductive adhesive.

### CROSS REFERENCE TO RELATED APPLICATIONS

This application is based upon and claims the benefit of priority from Japanese patent application No. 2024-051508, filed on Mar. 27, 2024, the disclosure of which is incorporated herein in its entirety by reference.

### BACKGROUND

The present disclosure relates to a battery.

In a battery in related art, a terminal is provided on the upper surface of each stacked rectangular cell. Recently, as disclosed in Patent Literature 1, a battery in which a terminal is provided on the end face in the longitudinal direction of each stacked rectangular cell has been developed.

Patent Literature 1: United States Patent Application Publication No., 2022/0302533

### SUMMARY

When such a battery is charged, the temperature in the vicinity of the terminal increases in each rectangular cell. That is, there has been a problem that the temperature locally rises inside the rectangular cells. Such a problem becomes particularly remarkable when the battery is quickly charged.

The present disclosure has been made in view of the above-described circumstances, and provides a battery capable of suppressing a local temperature rise inside rectangular cells during the charging of the battery.

A battery according to an aspect of the present disclosure includes:
a cell stack having a rectangular parallelepiped shape in which a plurality of rectangular cells with terminals disposed on both end faces in a longitudinal direction thereof are stacked on one another; and
a case configured to house the cell stack therein, in which
the cell stack includes a metal binding member configured to bind each of lower ends in the longitudinal direction of the plurality of rectangular cells, and
the binding member is fixed to the case by a thermally conductive adhesive.

In the battery according to an aspect of the present disclosure, each of both lower ends in the longitudinal direction of the cell stack is bound by a metal binding member, and the metal binding member is fixed to the case by a thermally conductive adhesive. Therefore, it is possible to release heat generated in the vicinity of the terminal during the charging of the battery to the case through the binding member and the thermally conductive adhesive. As a result, it is possible to suppress the local temperature rise inside the rectangular cells during the charging of the battery.

An insulating plate may be provided between the plurality of rectangular cells and the binding member, and a plurality of through holes provided in the insulating plate so as to respectively correspond to the plurality of rectangular cells may be filled with a thermally conductive material having an insulating property. By the above-described configuration, it is possible to increase the heat conduction between the rectangular cells and the binding member while ensuring the electrical insulation between the rectangular cells and the binding member.

The thermally conductive material may be the same material as that of the thermally conductive adhesive. By the above-described configuration, the battery can be easily manufactured.

The battery may further include a cooler below a bottom plate of the case. By the above-described configuration, it is possible to release heat generated in the cell stack during the charging of the battery more effectively from the bottom plate of the case through the binding member and the thermally conductive adhesive.

The binding member may be a metal band having an L-shape in cross section.

According to the present disclosure, it is possible to provide a battery capable of suppressing a local temperature rise inside rectangular cells during the charging of the battery.

The above and other objects, features and advantages of the present disclosure will become more fully understood from the detailed description given hereinbelow and the accompanying drawings.

### BRIEF DESCRIPTION OF DRAWINGS

FIG. 1 is a perspective view showing a cell stack in a battery according to a first embodiment;

FIG. 2 is a perspective view showing the cell stack in the battery according to the first embodiment;

FIG. 3 is a cross-sectional view showing the battery according to the first embodiment;

FIG. 4 is a perspective view showing the position of an insulating plate IP1 relative to rectangular cells C1 to C6; and

FIG. 5 is a perspective view showing the position of an insulating plate IP2 relative to the rectangular cells C1 to C6.

### DESCRIPTION OF EMBODIMENTS

Specific embodiments according to the present disclosure will be described hereinafter in detail with reference to the drawings. However, the present disclosure is not limited to the following embodiments. Further, for the clarification of the description, the following descriptions and the drawings are simplified as appropriate.

### First Embodiment

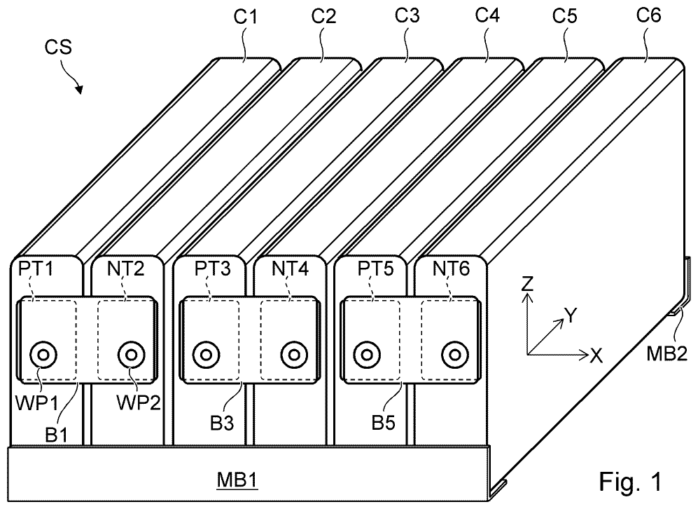

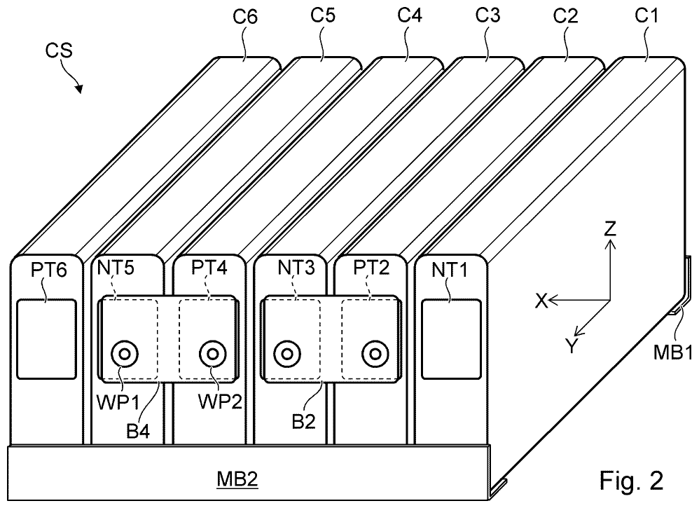

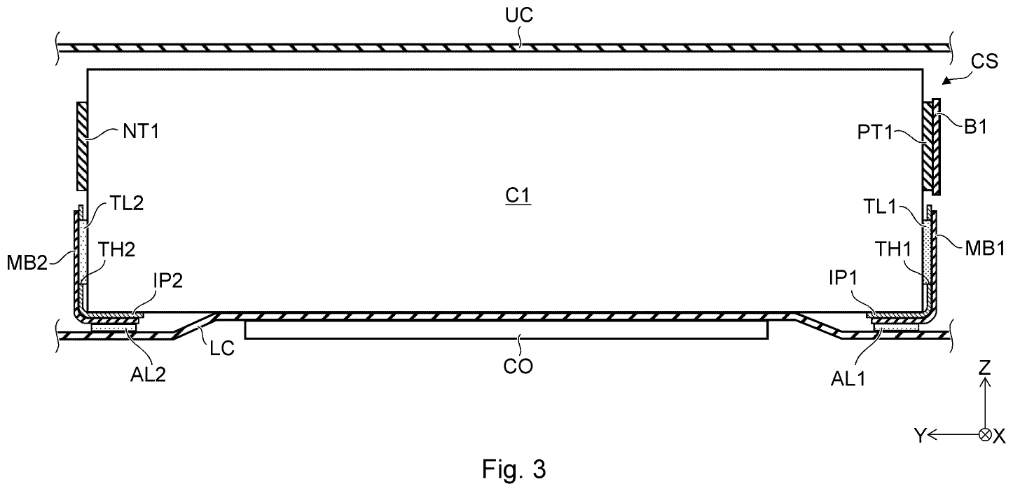

Firstly, a configuration of a battery according to a first embodiment will be described with reference to FIGS. 1 to 3. FIGS. 1 and 2 are both perspective views showing a cell stack in the battery according to the first embodiment. FIG. 3 is a cross-sectional view showing the battery according to the first embodiment.

The battery according to this embodiment is used, for example, for a vehicle-mounted battery. The vehicle in which the battery according to this embodiment is mounted is not limited to any particular vehicle. For example, the vehicle is an electric vehicle, a hybrid vehicle, a fuel cell vehicle, or the like that can be driven by electric power supplied from the battery.

Note that needless to say, the right-handed XYZ orthogonal coordinate system shown in each of FIGS. 1 to 3 and other drawings is shown for the sake of convenience in order to explain the positional relationship among components. In all the drawings such as FIG. 1, in general, the positive direction on the Z-axis is the vertically upward direction, and the XY-plane is parallel to the horizontal plane.

As shown in FIG. 3, the battery according to the first embodiment includes a cell stack CS, an upper case UC, a lower case LC, and a cooler CO. Note that as shown in FIGS. 1 and 2, the cell stack CS includes rectangular cells C1 to C6, bus bars B1 to B5, and metal bands MB1 and MB2, and as shown in FIG. 3, also includes adhesive layers AL1 and AL2, insulating plates IP1 and IP2, and thermally conductive layers TL1 and TL2.

Note that in FIG. 3, instead of cross-sectional views, side views of the rectangular cell C1 and the cooler CO are shown.

Firstly, the configuration of the cell stack CS will be described with reference to FIGS. 1 to 3.

As shown in FIGS. 1 and 2, the rectangular cells C1 to C6 are rectangular cells each having a rectangular parallelepiped shape extending in the Y-axis direction. The rectangular cells C1 to C6 are stacked on one another in the thickness direction (X-axis direction) and thereby form the cell stack CS. Each of the rectangular cells C1 to C6 is, for example, a secondary battery such as a lithium-ion battery or a nickel-metal hydride battery.

Note that, in FIGS. 1 and 2, the cell stack CS is shown in a simplified manner. Although the cell stack CS shown in FIGS. 1 and 2 is formed of six of the rectangular cells C1 to C6, it is usually formed of more rectangular cells. In fact, the number of rectangular cells forming the cell stack CS is not limited to any particular number, and may be any number of two or more.

Further, a heat insulating plate, a spacer for adjusting a distance between rectangular cells adjacent to each other, and/or the like (not shown) may be inserted between rectangular cells adjacent to each other. Further, end plates (not shown) may be provided at both ends in the stacking direction (X-axis direction) of the cell stack CS.

As shown in FIG. 1, a positive electrode terminal PT1 is provided on one end face (an end face on the Y-axis negative side) of the rectangular cell C1 in the longitudinal direction thereof. The positive electrode terminal PT1 shown in FIG. 1 has a rectangular shape in the XZ plan view and is provided so as to protrude outward from the end face of the rectangular cell C1. However, the present disclosure is not particularly limited thereto. Further, the positive electrode terminal PT1 shown in FIG. 1 is provided on the upper side (the Z-axis positive side) of the end face of the rectangular cell C1. The positive electrode terminal PT1 is made of, for example, a metal material such as copper having excellent electrical conductivity.

Similarly, as shown in FIG. 1, a negative electrode terminal NT2 is provided on one end face (an end face on the Y-axis negative side) of the rectangular cell C2 adjacent to the rectangular cell C1 in the longitudinal direction thereof. A positive electrode terminal PT3 is provided on one end face (an end face on the Y-axis negative side) of the rectangular cell C3 adjacent to the rectangular cell C2 in the longitudinal direction thereof. A negative electrode terminal NT4 is provided on one end face (an end face on the Y-axis negative side) of the rectangular cell C4 adjacent to the rectangular cell C3 in the longitudinal direction thereof. A positive electrode terminal PT5 is provided on one end face (an end face on the Y-axis negative side) of the rectangular cell C5 adjacent to the rectangular cell C4 in the longitudinal direction thereof. A negative electrode terminal NT6 is provided on one end surface (an end face on the Y-axis negative side) of the rectangular cell C6 adjacent to the rectangular cell C5 in the longitudinal direction thereof.

As shown in FIG. 1, each of the negative electrode terminal NT2 of the rectangular cell C2, the positive electrode terminal PT3 of the rectangular cell C3, the negative electrode terminal NT4 of the rectangular cell C4, the positive electrode terminal PT5 of the rectangular cell C5, and the negative electrode terminal NT6 of the rectangular cell C6 has a shape similar to that of the positive electrode terminal PT1 of the rectangular cell C1, and they are disposed in a manner similar to that in which the positive electrode terminal PT1 of the rectangular cell C1 is disposed.

Further, as shown in FIG. 1, the positive electrode terminal PT1 of the rectangular cell C1 and the negative electrode terminal NT2 of the rectangular cell C2, which are disposed so as to be adjacent to each other, are electrically connected to each other by the plate-like bus bar B1. Similarly, the positive electrode terminal PT3 of the rectangular cell C3 and the negative electrode terminal NT4 of the rectangular cell C4, which are disposed so as to be adjacent to each other, are electrically connected to each other by the bus bar B3 of plate-like. Similarly, the positive electrode terminal PT5 of the rectangular cell C5 and the negative electrode terminal NT6 of the rectangular cell C6, which are disposed so as to be adjacent to each other, are electrically connected by the plate-like bus bar B5.

Meanwhile, as shown in FIG. 2, a negative electrode terminal NT1 is provided on the other end face (an end face on the Y-axis positive side) of the rectangular cell C1 in the longitudinal direction thereof. Like the positive electrode terminal PT1 shown in FIG. 1, the negative electrode terminal NT1 shown in FIG. 2 has a rectangular shape in the XZ plan view and is provided so as to protrude outward from the end face of the rectangular cell C1. However, the present disclosure is not particularly limited thereto. Further, like the positive electrode terminal PT1 shown in FIG. 1, the negative electrode terminal NT1 shown in FIG. 2 is provided on the upper side (the Z-axis positive side) of the end face of the rectangular cell C1. Like the positive electrode terminal PT1, the negative electrode terminal NT1 is made of a metal material such as copper having excellent electrical conductivity.

Similarly, as shown in FIG. 2, a positive electrode terminal PT2 is provided on the other end face (an end face on the Y-axis positive side) of the rectangular cell C2 adjacent to the rectangular cell C1 in the longitudinal direction thereof. A negative electrode terminal NT3 is provided on the other end face (an end face on the Y-axis positive side) of the rectangular cell C3 adjacent to the rectangular cell C2 in the longitudinal direction thereof. A positive electrode terminal PT4 is provided on the other end face (an end face on the Y-axis positive side) of the rectangular cell C4 adjacent to the rectangular cell C3 in the longitudinal direction thereof. A negative electrode terminal NT5 is provided on the other end face (an end face on the Y-axis positive side) of the rectangular cell C5 adjacent to the rectangular cell C4 in the longitudinal direction thereof. A positive electrode terminal PT6 is provided on the other end face (an end face on the Y-axis positive side) of the rectangular cell C6 adjacent to the rectangular cell C5 in the longitudinal direction thereof.

As shown in FIG. 2, each of the positive electrode terminal PT2 of the rectangular cell C2, the negative electrode terminal NT3 of the rectangular cell C3, the positive electrode terminal PT4 of the rectangular cell C4, the negative electrode terminal NT5 of the rectangular cell C5, and the positive electrode terminal PT6 of the rectangular cell C6 has a shape similar to that of the negative electrode terminal NT1 of the rectangular cell C1, and they are disposed in a manner similar to that in which the negative electrode terminal NT1 of the rectangular cell C1 is disposed.

Further, as shown in FIG. 2, the positive electrode terminal PT2 of the rectangular cell C2 and the negative electrode terminal NT3 of the rectangular cell C3, which are disposed so as to be adjacent to each other, are electrically connected to each other by the plate-like bus bar B2. Similarly, the positive electrode terminal PT4 of the rectangular cell C4 and the negative electrode terminal NT5 of the rectangular cell C5, which are disposed so as to be adjacent to each other, are electrically connected to each other by the plate-like bus bar B4. As described above, in the cell stack CS shown in FIGS. 1 and 2, the rectangular cells C1 to C6 are connected to each other in series by the bus bars B1 to B5.

Note that the negative electrode terminal NT1 of the rectangular cell C1 shown in FIG. 2 is connected to the positive electrode terminal of another cell stack through, for example, a bus bar (not shown). However, the present disclosure is not particularly limited thereto. Further, the positive electrode terminal PT6 of the rectangular cell C6 shown in FIG. 2 is connected to the negative electrode terminal of yet another cell stack through, for example, a bus bar (not shown). However, the present disclosure is not particularly limited thereto. By the above structure, for example, a plurality of cell stacks can be connected to each other in series.

Since the bus bars B1 to B5 shown in FIGS. 1 and 2 have structures similar to each other, the bus bar B1 will be described. As shown in FIG. 1, the bus bar B1 is a plate-like member that electrically connects the positive electrode terminal PT1 of the rectangular cell C1 to the negative electrode terminal NT2 of the rectangular cell C2 which are disposed so as to be adjacent to each other. The bus bar B1 is made of, for example, a metal material such as copper having excellent electrical conductivity.

As shown in FIG. 1, the bus bar B1 is, for example, a plate-like member having a rectangular shape in the XZ-plan view. The bus bar B1 is provided so as to cover roughly the entire positive terminal PT1 of the rectangular cell Cl and the entire negative terminal NT2 of the rectangular cell C2. The bus bar B1 includes a pair of welding parts WP1 and WP2 welded to the positive terminal PT1 of the rectangular cell C1 and the negative terminal NT2 of the rectangular cell C2, respectively, which are arranged adjacent to each other.

The welding parts WP1 and WP2 shown in FIG. 1 are provided near both ends in the X-axis direction of the bus bar B1 at the lower part thereof (i.e., the part on the Z-axis negative side thereof). However, the positions of the welding parts WP1 and WP2 are not limited to any particular place. Note that FIG. 1 shows the welding parts WP1 and WP2 before they are welded. The welding parts WP1 and WP2 shown in FIG. 1 are counterbored, so that the areas of the bus bar in which they are provided are thinner than the remaining area, i.e., the area therearound, of the bus bar. Further, each of the welding parts WP1 and WP2 shown in FIG. 1 has a circular shape in the XZ-plan view, and a through hole is formed at its center.

The welding method is not limited to any particular method. For example, the bus bar B1 is welded to the positive terminal PT1 of the rectangular cell C1 at the welding part WP1 by applying a laser beam to the welding part WP1 from the Y-axis negative side thereof. Similarly, the bus bar B1 is welded to the negative terminal NT2 of the rectangular cell C2 at the welding part WP2 by applying a laser beam to the welding part WP2 from the Y-axis negative side thereof.

As shown in FIGS. 1 and 2, the metal bands (binding members) MB1 and MB2 are metal members each of which has an L-shape in YZ-cross section and extends over the entire length of the cell stack CS in the stacking direction. The metal bands MB1 and MB2 band bind, i.e., retain, both lower ends in the longitudinal direction of the rectangular cells C1 to C6 (i.e., the cell stack CS).

Note that the metal bands MB1 and MB2 may be divided into a plurality of sections, and the plurality of sections are arranged over the entire length of the cell stack CS.

More specifically, as shown in FIG. 3, the metal band MB1 is provided in an L-shape in YZ-cross section along the lower corners on the Y-axis negative side of the rectangular cells C1 to C6, and includes a bottom plate that supports the bottom surfaces of the rectangular cells C1 to C6 and a side plate that supports the end faces of the rectangular cells C1 to C6. Similarly, the metal band MB2 is provided in an L-shape in YZ-cross section along the lower corners on the Y-axis positive side of the rectangular cells C1 to C6, and includes a bottom plate that supports the bottom surfaces of the rectangular cells C1 to C6 and a side plate that supports the end faces of the rectangular cells C1 to C6.

Each of the metal bands MB1 and MB2 may not have an L-shape in YZ-cross section, but may have, for example, a flat plate-like shape.

As shown in FIG. 3, the adhesive layer ALI is made of a thermally conductive adhesive and fixes the metal band MB1 to the bottom plate of the lower case LC. Similarly, the adhesive layer AL2 is made of a thermally conductive adhesive and fixes the metal band MB2 to the bottom plate of the lower case LC.

The thermally conductive adhesive, of which the adhesive layers AL1 and AL2 are made, is, for example, an adhesive having a thermal conductivity of 1 W/m·K or higher. The thermally conductive adhesive may have an insulating property.

Note that the metal bands MB1 and MB2 may be fixed to, for example, a side plate of the case or a bracket constituting a part of the case with the adhesive layers AL1 and AL2 interposed therebetween.

In the battery shown in FIG. 3, heat generated in the vicinity of the positive terminal PT1 of the rectangular cell C1 during the charging of the battery can be released to the bottom plate of the lower case LC through the metal band MB1 and the adhesive layer AL1. Similarly, heat generated in the vicinity of the negative terminal NT1 of the rectangular cell C1 during the charging of the battery can be released to the bottom plate of the lower case LC through the metal band MB2 and the adhesive layer AL2. That is, by connecting the metal bands MB1 and MB2 to the lower case LC through the adhesive layers AL1 and AL2, the local temperature rise inside the rectangular cell C1 during the charging of the battery can be suppressed.

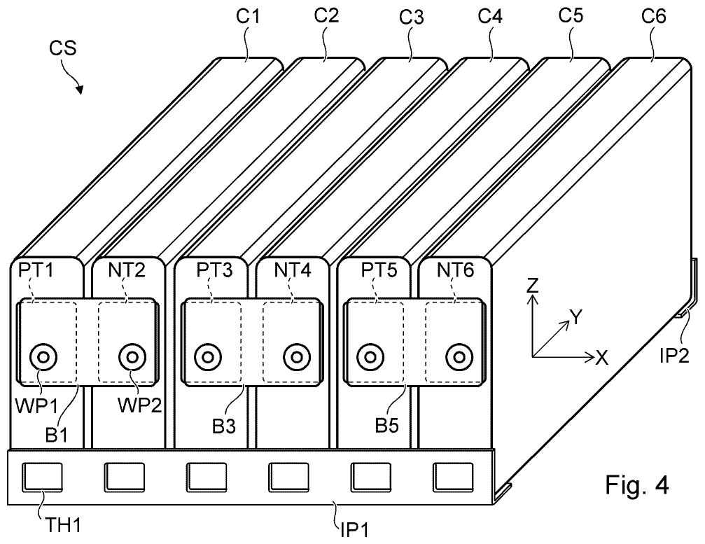

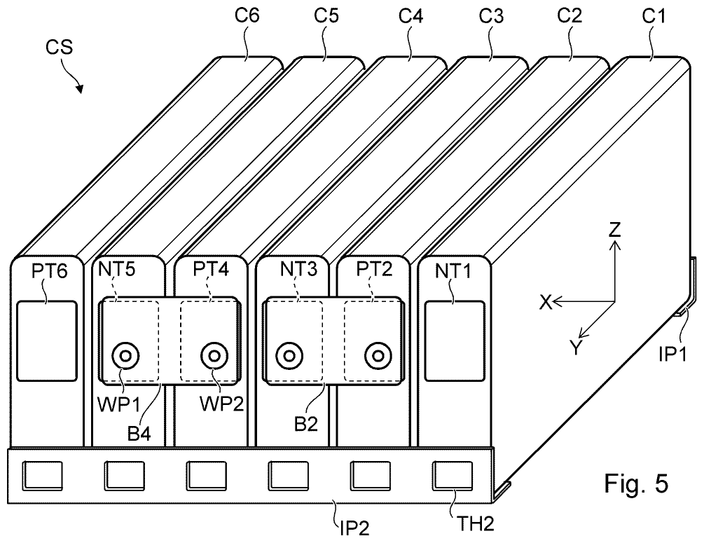

The insulating plates IP1 and IP2 will be described hereinafter with reference to FIGS. 4 and 5 as well as FIG. 3. FIG. 4 is a perspective view showing the position of the insulating plate IP1 relative to the rectangular cells C1 to C6. FIG. 5 is a perspective view showing the position of the insulating plate IP2 relative to the rectangular cells C1 to C6.

As shown in FIGS. 4 and 5, each of the insulating plates IP1 and IP2 is an insulating member having an L-shape in YZ-cross section and extending over the entire length of the cell stack CS in the stacking direction. The insulating plates IP1 and IP2 are made of, for example, a resin.

Note that as shown in FIG. 4, six through holes TH1 are provided so as to correspond to the rectangular cells C1 to C6, respectively, in the insulating plate IP1. Similarly, as shown in FIG. 5, six through holes TH2 are provided so as to correspond to the rectangular cells C1 to C6, respectively, are provided in the insulating plate IP2.

Although the through holes TH1 and TH2 shown in FIGS. 4 and 5 are rectangular in XZ-plan view, they may be, for example, circular or elliptical. That is, their shapes are not limited in any particular shape.

Meanwhile, as shown in FIG. 3, the insulating plate IP1 is provided between the rectangular cells C1 to C6 and the metal band MB1 at the lower corners on the Y-axis negative side of the rectangular cells C1 to C6, and electrically insulates the rectangular cells C1 to C6 from the metal band MB1. Similarly, the insulating plate IP2 is provided between the rectangular cells C1 to C6 and the metal band MB2 at the lower corners on the Y-axis positive side of the rectangular cells C1 to C6, and electrically insulates the rectangular cells C1 to C6 from the metal band MB2.

Further, the insulating plates IP1 and IP2 shown in FIG. 3 have L-shapes in YZ-cross section corresponding to the shapes of the metal bands MB1 and MB2, respectively, are slightly larger than the metal bands MB1 and MB2, respectively, and are disposed so as to protrude from the metal bands MB1 and MB2, respectively. However, the shapes and sizes of the insulating plates IP1 and IP2 are not limited to any particular shapes and sizes.

The thermally conductive layer TL1 is made of a thermally conductive material having an insulating property, and as shown in FIG. 3, each of the through holes TH1 provided in the insulating plate IP1 is filled with the same thermally conductive material. That is, the thermally conductive layer TL1 thermally connects the metal band MB1 and the rectangular cells C1 to C6 to each other while electrically insulating them from each other.

Similarly, the thermally conductive layer TL2 is made of a thermally conductive material having an insulating property, and each of the through holes TH2 provided in the insulating plate IP2 is filled with the same thermally conductive material. That is, the thermally conductive layer TL2 thermally connects the metal band MB2 and the rectangular cells C1 to C6 to each other while electrically insulating them from each other.

By the above-described configuration, in the battery shown in FIG. 3, heat generated in the vicinity of the positive terminal PT1 of the rectangular cell C1 during the charging of the battery can be released to the bottom plate of the lower case LC through thermally conductive layer TL1, the metal band MB1, and the adhesive layer AL1. Similarly, heat generated in the vicinity of the negative terminal NT1 of the rectangular cell C1 during the charging of the battery can be released to the bottom plate of the lower case LC through the thermally conductive layer TL2, the metal band MB2, and the adhesive layer AL2.

That is, by connecting the metal bands MB1 and MB2, which are connected to the lower case LC by the adhesive layers AL1 and AL2, to the rectangular cells C1 to C6 by the thermally conductive layers TL1 and TL2, the local temperature rise inside the rectangular cell C1 during the charging of the battery can be further suppressed.

Note that the thermally conductive material of which the thermally conductive layers TL1 and TL2 are made may be the same material as that of the thermally conductive adhesive of which the adhesive layers AL1 and AL2 are made. By the above-described configuration, the battery can be easily manufactured.

It should be noted that the insulating plates IP1 and IP2 are not indispensable as long as the rectangular cells C1 to C6 and the metal bands MB1 and MB2 can be electrically insulated from each other. Therefore, the thermally conductive layers TL1 and TL2 are also not indispensable.

As shown in FIG. 3, the upper case UC and the lower case LC constitute a case for housing the cell stack CS therein. The upper case UC is a metal plate covering the upper surface of the cell stack CS, and the lower case LC is a metal plate supporting the bottom surface of the cell stack CS. The bottom surface of the cell stack CS (i.e., the rectangular cells C1 to C6) and the upper surface of the lower case LC are electrically insulated by, for example, a thermally conductive layer having an insulating property (not shown).

Note that a plurality of cell stacks CS may be arranged side by side in the Y-axis direction inside the case (i.e., between the upper case UC and the lower case LC).

The cooler CO cools the cell stack CS, i.e., the rectangular cells C1 to C6. As shown in FIG. 3, the cooler CO extends over the entire length of the cell stack CS in the stacking direction (X-axis direction) while being in contact with the bottom surface of the lower case LC. For example, a plurality of refrigerant tubes extending in the X-axis direction are arranged side by side in the Y-axis direction inside the cooler CO. However, the configuration of the buttery is not limited to such a configuration. The refrigerant flowing in the refrigerant tubes is, for example, water.

The central parts in the longitudinal direction (Y-axis direction) of the rectangular cells C1 to C6 are cooled by the cooler CO through the lower case LC. Meanwhile, the end parts in the longitudinal direction of the rectangular cells C1 to C6 are cooled by the cooler CO through the thermally conductive layer TL1, the metal band MB1, the adhesive layer AL1, and the lower case LC.

As described above, in the battery according to this embodiment, both lower ends in the longitudinal direction of the cell stack CS are respectively bound, i.e., retained, by the metal bands MB1 and MB2 each having an L-shape in cross section, and the metal bands MB1 and MB2 are fixed to the bottom plate of the lower case LC by the adhesive layers AL1 and AL2 made of a thermally conductive adhesive.

Therefore, heat generated in the vicinity of the positive terminals PT1 to PT6 and the negative terminals NT1 to NT6 of the rectangular cells C1 to C6 during the charging of the battery can be released to the bottom plate of the lower case LC through the metal bands MB1 and MB2 and the adhesive layers AL1 and AL2. As a result, the local temperature rise inside the rectangular cells C1 to C6 during the charging of the battery can be suppressed.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A battery comprising:
a cell stack having a rectangular parallelepiped shape in which a plurality of rectangular cells with terminals disposed on both end faces in a longitudinal direction thereof are stacked on one another; and
a case configured to house the cell stack therein, wherein
the cell stack comprises a metal binding member configured to bind each of lower ends in the longitudinal direction of the plurality of rectangular cells, and
the binding member is fixed to the case by a thermally conductive adhesive.

2. The battery according to claim 1, wherein
an insulating plate is provided between the plurality of rectangular cells and the binding member, and
a plurality of through holes provided in the insulating plate so as to respectively correspond to the plurality of rectangular cells are filled with a thermally conductive material having an insulating property.

3. The battery according to claim 2, wherein the thermally conductive material is the same material as that of the thermally conductive adhesive.

4. The battery according to claim 1, further comprising a cooler below a bottom plate of the case.

5. The battery according to claim 1, wherein the binding member is a metal band having an L-shape in cross section.
